(19) United States
(12) Patent Application Publication
(10) Pub. No.: US 2004/0148464 A1
(43) Pub. Date: Jul. 29, 2004

(54) Cache memory device and method of controlling the cache memory device

(76) Inventor: Ho-Rang Jang, Bucheon-city (KR)

Correspondence Address: HARNESS, DICKEY & PIERCE, P.L.C., P.O. BOX 8910, RESTON, VA, 20195, US

(21) Appl. No.: 10/759,270

(22) Filed: Jan. 20, 2004

(30) Foreign Application Priority Data
Jan. 21, 2003 (KR) 2003-4024

(51) Int. Cl. G06F 12/08

(52) U.S. Cl. 711/120; 711/125; 711/141

(57) ABSTRACT

A cache memory device for a digital signal processor (DSP) may include a cache memory for providing an instruction to a DSP core of the DSP in response to a request from the DSP core, and another cache memory for enabling a running flag signal in response to an interrupt signal received from the DSP core. The cache memory that enables the running flag may provide a given number of instructions that are different from the first provided instruction, in response to further requests for instructions from the DSP core. Additionally, the cache memory handling the given number of different instructions may disable the running flag signal and cease providing the different instructions when the given number of instructions reaches a threshold value. The above process may be iteratively repeated until there are no further instruction requests from the DSP core to be processed.

### PRIORITY STATEMENT

This application claims the priority of Korean Patent Application No. 2003-4024, filed on Jan. 21, 2003, in the Korean Intellectual Property Office, the disclosure of which is incorporated herein in its entirety by reference.

### BACKGROUND OF THE INVENTION

1. Field of the Invention

The present invention relates to a cache memory device and method of controlling the cache memory device.

2. Description of the Related Art

In general, cellular phones, video cameras, and multimedia systems use digital signal processors (DSPs) for processing voice signals and image signals. A conventional DSP includes program memory for storing application programs, including signal processing instructions. As application programs become larger and more diversified, the program memory requires an increased storage capacity. Nonetheless, it is difficult to install a program memory having larger storage capacity into a DSP.

This problem, however, can be addressed by providing the conventional DSP with cache memory having smaller storage capacity, which can store part of the instructions that are typically stored in the program memory. By installing cache memory for storing instructions, the number of program memory accesses decrease, and DSP operation speed increases because the amount of time taken to access the cache memory is shorter than the time taken to access the program memory. Therefore, the conventional DSP can process voice signals or video signals at higher speeds.

FIG. 1 is a block diagram of a prior art digital signal processor and program memory. Referring to FIG. 1, a DSP 30 includes a DSP core 10 and a cache memory device 20. The DSP 30 is connected to program memory 40 having sufficient storage capacity (to store applications and instructions) via a system bus 1. The DSP core 10 executes a variety of programs required for digital signal processing and performs an interrupt service routine in response to an interrupt request. The cache memory device 20 provides necessary instructions for the execution of the programs to the DSP core 10. If there are no instructions necessary for the DSP core 10 to carry out the interrupt service routine in the cache memory device 20, the cache memory device 20 reads the corresponding instructions from the program memory 40 and provides the read instructions to the DSP core 10.

FIG. 2 is a block diagram of a prior art cache memory device. Referring to FIG. 2, a cache memory device 50 includes cache memory 52, and first interface unit 51 and second interface unit 53. The cache memory 52 stores instructions INS frequently used by the DSP core 10 of FIG. 1 and provides the instructions to the DSP core 10 whenever the DSP core 10 requests them. For example, if the cache memory 52 has the instructions INS requested by the DSP core 10, it outputs a hit signal HIT to the first interface 51. Otherwise, the cache memory 52 outputs a miss signal MISS.

If the cache memory 52 has the requested instructions INS, it outputs the requested instructions INS to the DSP core 52 together with the hit signal HIT. Otherwise, the cache memory 52 outputs a program address PRO_ADD corresponding to the requested instructions INS to the second interface 53. In addition, the cache memory 52 outputs the miss signal MISS to the first interface 51. When the miss signal MISS is output from the cache memory 52, the first interface 51 outputs a wait signal WAIT to the DSP core 10 so that no further requests for the instructions INS are issued by the DSP core 10.

The first interface 51 transmits the program address PRO_ADD requested by the DSP core 10 to the cache memory 52. In addition, the first interface 51 transmits the instructions INS output from the cache memory 52 to the DSP core 10, in response to the hit signal HIT. The second interface 53 transmits the program address PRO_ADD, output from the cache memory 52, to the program memory 40 of FIG. 1. The second interface 53 transmits the instructions INS, corresponding to the program address PRO_ADD received from the program memory 40, to the cache memory 52.

The cache memory device thus stores instructions frequently used by a DSP core. Therefore, it is possible to reduce the number of access times to program memory, which has relatively large storage capacity, and eventually increase the operation speed of a DSP.

If an interrupt request is issued, the DSP core stops performing a current operation and carries out an interrupt service routine. The DSP core then resumes the operation that it had previously stopped due to the interrupt request. Since instructions used in the interrupt service routine are used less frequently, there is typically a low possibility that the instructions are being stored in the cache memory. Therefore, the instructions necessary for the interrupt service routine are typically read from the program memory rather than from the cache memory.

The interrupt service routine should be quickly executed in real time. However, since a ‘general use’ cache memory only stores instructions frequently used in the DSP core, operation speed is very slow. The speed at which the interrupt service routine is performed depends on how quickly the cache memory provides instructions, necessary for the initiation of the interrupt service routine, to the DSP core. Therefore, it is not preferable for a cache memory having low operation speed to provide the instructions for an interrupt service routine to the DSP core.

Depending on the operation state of the DSP core, the amount of time taken for the DSP core to execute a given application program may vary. The amount of time taken for the DSP core to execute the given application program typically is minimally shorter than the time taken for the DSP core to execute the given application program while executing a plurality of other programs. Therefore, it is very difficult to estimate how much time it will take the DSP core to execute an application program. In addition, since the amount of time taken for the DSP core to execute a given application program may vary depending on the operation state of the DSP core, the cache memory for general use cannot quickly respond to an interrupt request for a program that needs to be processed within a given amount of time.

The cache memory typically only stores the instructions that are used frequently in the DSP core. Therefore, in a case where an interrupt request is issued, the cache memory accesses the program memory to load the instructions necessary for the interrupt service routine. This access function increases the power consumption of a chip that contains the cache memory.

In an effort to solve the above-mentioned problems, a cache memory device, including an interrupt descriptor cache, in which a microprocessor stores interrupt information (i.e., the instructions necessary for the interrupt service routine), has been disclosed in U.S. Pat. No. 6,378,023 to Christie et al., entitled “Interrupt Descriptor Cache for a Microprocessor”. In the cache memory device of the '023 patent, the microprocessor loads the interrupt information from the interrupt descriptor cache rather than from main memory. Here, an interrupt service routine is rarely used and needs instructions having various sizes, for example, from several tens to several million instructions, according to the field of application. Accordingly, for an interrupt service routine requiring several million instructions, there is a limitation in storing all of the interrupt information in the interrupt descriptor cache.

### SUMMARY OF THE INVENTION

Exemplary embodiments of the present invention are directed to a method of controlling a cache memory device and a cache memory device for a digital signal processor (DSP). The cache memory device may include a cache memory for providing an instruction to a DSP core of the DSP in response to a request from the DSP core, and another cache memory for enabling a running flag signal in response to an interrupt signal received from the DSP core. The cache memory that enables the running flag may provide a given number of instructions that are different from the first provided instruction, in response to further requests for instructions from the DSP core. Additionally, the cache memory handling the given number of different instructions may disable the running flag signal and cease providing the different instructions when the given number of instructions reaches a threshold value. The above process may be iteratively repeated until there are no further instruction requests from the DSP core to be processed.

### BRIEF DESCRIPTION OF THE DRAWINGS

The above and other features and advantages of the present invention will become more apparent by describing, in detail, exemplary embodiments thereof with reference to the attached drawings in which:

FIG. 1 is a block diagram of a prior art digital signal processor and program memory.

FIG. 2 is a block diagram of a prior art cache memory device.

FIG. 3 is a block diagram of a cache memory device in accordance with an exemplary embodiment of the present invention.

FIG. 4 is a block diagram of first cache memory shown in FIG. 3.

FIG. 5 is a diagram illustrating a cache memory block shown in FIG. 4.

FIG. 6 is a flowchart describing a method of operating a cache memory device in accordance with an exemplary embodiment of the present invention.

FIG. 7 is a flowchart describing function 2400 from FIG. 6 in further detail.

FIG. 8 is a block diagram of a cache memory device in accordance with another exemplary embodiment of the present invention.

FIG. 9 is a detailed block diagram of first cache memory shown in FIG. 8.

FIG.10 is a block diagram of second cache memory shown in FIG. 8.

FIG. 11 is a flowchart describing a method of operating a cache memory device in accordance with another exemplary embodiment of the present invention.

FIG. 12 is a detailed block diagram of third cache memory shown in FIG. 8.

FIG. 13 is a block diagram illustrating a comparison of the input bandwidth of cache memory for an interrupt service routine with the input bandwidth of cache memory for general use.

### DETAILED DESCRIPTION OF THE EXEMPLARY EMBODIMENTS

Exemplary embodiments of the present invention are directed to a cache memory device for a digital signal processor (DSP), which is capable of quickly responding to an interrupt request with lower power consumption, and to a method of controlling the cache memory device. The exemplary embodiments of the present invention will be described more fully with reference to the accompanying drawings in which like reference numerals in different drawings represent like elements.

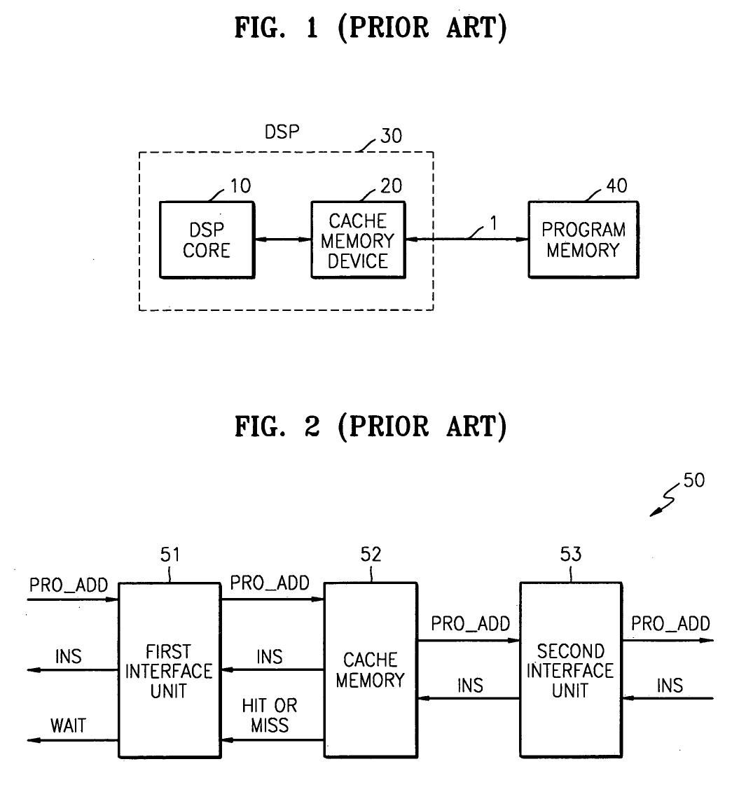

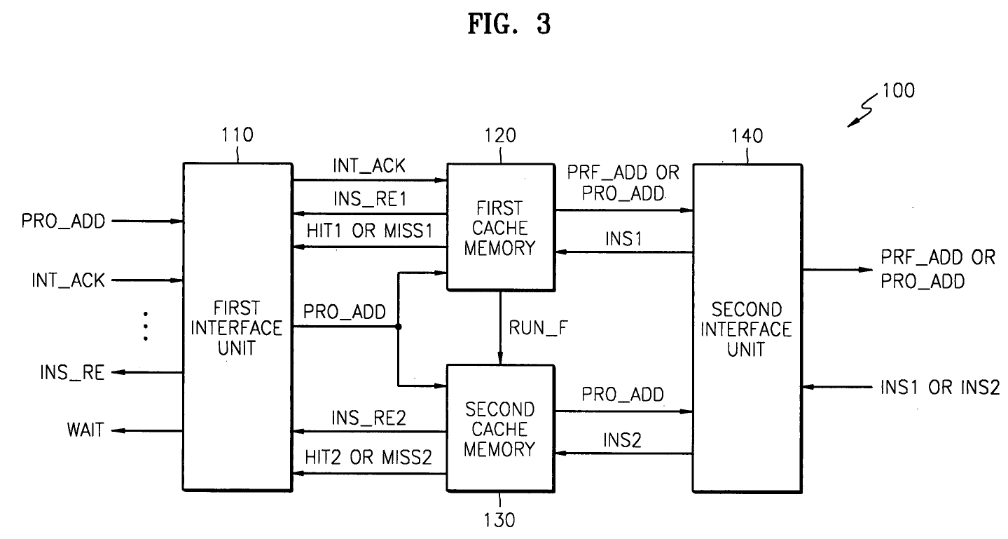

FIG. 3 is a block diagram of a cache memory device in accordance with an exemplary embodiment of the present invention. Referring to FIG. 3, a low power consumption cache memory device 100 may include a first interface unit 110, first cache memory 120, second cache memory 130, and a second interface unit 140. The first interface unit 110 receives a program address PRO_ADD and an interrupt signal INT_ACK from a digital signal processor (DSP) core (such as DSP core 10 of FIG. 1). The first interface unit 110 may receive signals that may be used for writing data or reading data for control of the first cache memory 120 and the second cache memory 130.

The first interface unit 110 transmits the program address PRO_ADD to the first cache memory 120 and to the second cache memory 130 and transmits the interrupt signal INT_ACK to the first cache memory 120. The first cache memory 120 outputs a first instruction INS_RE1 together with a hit signal HIT1 to the first interface unit 110. The first interface unit 110 transmits the first instruction INS_RE1 to the DSP core 10. The second cache memory 130 outputs a second instruction INS_RE2 together with a hit signal HIT2 to the first interface unit 110. Here, the terms ‘first’ and ‘second’, as used in the context of a ‘first instruction’ and a ‘second instruction’, may be used to distinguish the instruction provided by the first cache memory 120 and the instruction provided by the second cache memory 130, for example.

The first instruction INS_RE1 provided by first cache memory 120 may be used to instruct the DSP core 10 to check an interrupt request state, and the read related input variables, when the DSP core 10 executes an interrupt service routine, for example. The second instruction INS_RE2 provided by second cache memory 130 may be used to instruct the DSP core 10 to execute a regular program, or may be an instruction that is to be provided to DSP core 10 after the first cache memory 120 has provided all INS_RE1s for checking interrupt request state, and reading related input variables during the interrupt service routine.

The first interface unit 110 transmits the second instruction INS_RE2 to the DSP core 10. When the first interface unit 110 receives miss signal MISS1 from the first cache memory 120 and miss signal MISS2 from the second cache memory 130, the first interface unit 110 outputs a wait signal WAIT to the DSP core 10 so that the DSP core 10 does not ask for any further instructions.

The first cache memory 120 may be embodied as an interrupt cache memory, for example, which operates in response to the reception of the interrupt signal INT_ACK. When first cache memory 120 receives the interrupt signal INT_ACK, the first cache memory 120 enables a running flag signal RUN_F. When enabled, the running flag signal RUN_F indicates a state where an instruction can be provided in response to an interrupt request. If the first instruction INS_RE1 (corresponding to the program address PRO_ADD) exists, the first cache memory 120 outputs the first instruction INS_RE1 together with the hit signal HIT1. Simultaneously while outputting the hit signal HIT1 and the first instruction INS_RE1, the first cache memory 120 generates a prefetch address PRF_ADD for output to the second interface unit 140. The prefetch address PRF_ADD includes a plurality of addresses. Each of the addresses may consecutively increase in value from the program address PRO_ADD. In response to the prefetch address PRF_ADD, the second interface unit 140 sends a first write instruction INS1 that is stored in the first cache memory 120.

If the first instruction INS_RE1 does not exist or is not valid, the first cache memory 120 outputs the miss signal MISS1 to the first interface unit 110. Thereafter, the first cache memory 120 outputs the program address PRO_ADD to the second interface unit 140 and receives the first write instruction INS1, corresponding to the program address PRO_ADD, from the second interface unit 140.

After the first cache memory 120 has output a given number of first instructions INS_RE1 (after reaching a threshold value or a preset number or value of instructions to output), the first cache memory 120 ceases operations and disables the running flag signal RUN_F. The given number of first instructions INS_RE1 may be equal to the number of instructions necessary for the DSP core 10 to check an interrupt request state and to read relevant input variables, for example.

The second cache memory 130 may operate when the running flag signal RUN_F is disabled. If a second instruction INS_RE2, corresponding to the program address PRO_ADD, exists, the second cache memory 130 outputs the second instruction INS_RE2 together with the hit signal HIT2 to the first interface unit 110. If the second instruction INS_RE2 does not exist or is not valid, the second cache memory 130 outputs the miss signal MISS2 to the first interface unit 110. Thereafter, the second cache memory 130 may output the program address PRO_ADD to the second interface unit 140, in order to receive a second write instruction INS2 from the second interface unit 140. Accordingly, the second cache memory 130 may provide instructions necessary for the DSP core 10 to execute a regular program, or instructions necessary for executing an interrupt service routine after the DSP core 10 reads certain input variables, for example. Here, the certain input variables can be used as position coordinates of a pointer indicating the movement direction of a mouse, for example, when a particular program is selected by external input devices (such as a mouse) to execute the program. The selection of the program by the external input device may cause an interrupt. A computer CPU may thus determine the cause of the interrupt, that is, which program is selected, from the position coordinates of the pointer.

The second interface unit 140 may receive the prefetch address PRF_ADD or the program address PRO_ADD from the first cache memory 120 and may transmit the prefetch address PRF_ADD or the program address PRO_ADD to a program memory of larger storage capacity (such as memory 40 of FIG. 1). The second interface unit 140 receives the program address PRO_ADD output from the second cache memory 130 and transmits the program address PRO_ADD to the program memory 40. In response, program memory 40 outputs the first write instruction INS1 to the second interface unit 140, which transmits the first write instruction INS1 to the first cache memory 120. Alternatively, if the second interface unit 140 receives the second write instruction INS2 from the program memory 40, the second interface unit 140 transmits the received second write instruction INS2 to the second cache memory 130.

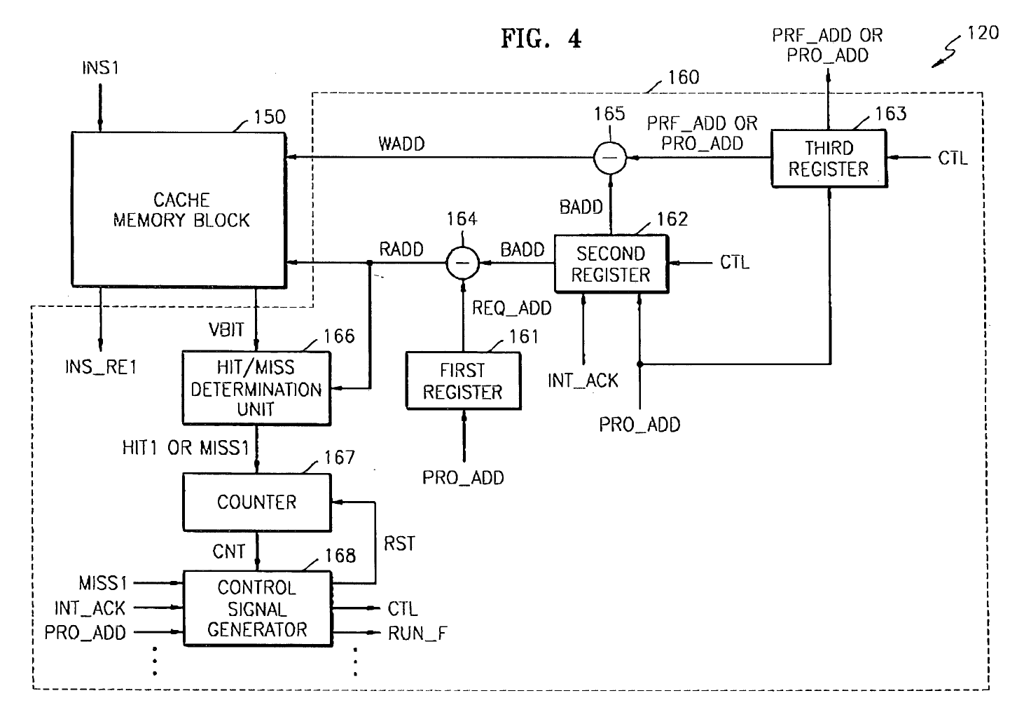

FIG. 4 is a detailed block diagram of the first cache memory 120 of FIG. 3. Referring to FIG. 4, the first cache memory 120 may include a cache memory block 150. The cache memory block 150 may include a plurality of storage registers 151. Each of the storage registers 151 may include an N-bit storage space (where N may be a integer numeral greater than 1, for example) and a valid bit V indicating whether or not instructions stored therein are valid. The N bits may be divided into a given number of words that may be read at one time, for example.

First cache memory 120 may also include a cache controller 160. The cache controller 160 may include a first register 161 that receives the program address PRO_ADD from the first interface unit 110 and outputs a request address REQ_ADD. The REQ_ADD is the same as the PRO_ADD input to first register 161, for example. The cache controller 160 may also include a second register 162 that receives the interrupt signal INT_ACK from the first interface unit 110, stores the program address PRO_ADD that is the first received from the first interface unit 110, and sets the program address PRO_ADD as a start address BADD. The BADD is thus the PRO_ADD initially input to second register 162 when the first cache memory receives the interrupt signal INT_ACK from the first interface unit 110. The program address PRO_ADD is received and stored in second register 162 when a given control signal CTL is input thereto. The second register 162 resets the start address BADD with the corresponding program address PRO_ADD.

The cache controller 160 includes a third register 163 that stores the first received program address PRO_ADD, and creates the prefetch address PRF_ADD. The PRF_ADD may represent one of a plurality of program addresses that consecutively increase (in value or number) from the first received program address PRO_ADD. In other words, the third register 163 creates a PRF_ADD that represents one or more of the PRO_ADDs stored in first cache memory 120. The third register 163 outputs the prefetch address PRF_ADD to the program memory 40. Also, and upon input of the control signal CTL, the third register 163 stores the program address PRO_ADD input thereto. The third register 163 creates the prefetch address PRF_ADD and transmits the prefetch address PRF_ADD to the program memory 40. The prefetch address PRF_ADD may represent a plurality of program addresses consecutively increase (in value or number) from the stored program address PRO_ADD.

The cache controller 160 may include a first subtraction unit 164 and a second subtraction unit 165. The first subtraction unit 164 creates a read address RADD by subtracting the start address BADD from the request address REQ_ADD. The second subtraction unit 165 creates a write address WADD by subtracting the start address BADD from the prefetch address PRF_ADD or the program address PRO_ADD, which has been received together with the control signal CTL.

The cache controller 160 may include a hit/miss determination unit 166. The hit/miss determination unit 166 receives the read address RADD and outputs the miss signal MISS1 if the read address RADD is greater than a maximum address value in a given address range of the cache memory block 150 or smaller than a minimum address value in the given address range of the cache memory block 150.

When the read address RADD is within the given address range of the cache memory block 150, the hit/miss determination unit 166 receives a valid bit VBIT from the storage register 151 of the cache memory block 150. Based on the valid bit VBIT, the hit/miss determination unit 166 determines whether or not data corresponding to the read address RADD is valid. If the data corresponding to the read address RADD is valid, the hit/miss determination unit 166 outputs the hit signal HIT1. Otherwise, the hit/miss determination unit 166 outputs the miss signal MISS1.

The third register 163 outputs the prefetch address PRF_ADD while outputting the hit signal HIT1. The third register 163 outputs the program address PRO_ADD, which is received together with the control signal CTL, while outputting the miss signal MISS1. The cache controller 160 may include a counter 167. As shown in FIG. 4, the counter 167 counts the number of times the hit signal HIT1 is output and accumulates the count value and output the accumulated count value CNT. The counter 167 is reset in response to a reset signal RST.

The cache controller 160 may include a control signal generator 168. The control signal generator 168 may receive a plurality of signals, including the miss signal MISS1, the interrupt signal INT_ACK, the program address PRO_ADD, and the accumulated count value CNT. The control signal generator 168 may further receive signals such as the read address RADD and the valid bit information VBIT. The control signal generator 168 outputs the control signal CTL when the miss signal MISS1 is received. The control signal generator 168 compares the accumulated count value CNT with a given number or threshold. When the accumulated count value CNT equals the given number or threshold, the control signal generator 168 determines that the number of first instructions INS_RE1 (that are provided to the DSP core 10) reaches a given number or threshold and disables the running flag signal RUN_F. At this time, the control signal generator 168 output the reset signal RST to the counter 167. Here, the control signal generator 168 may also output additional control signals other than the control signal CTL.

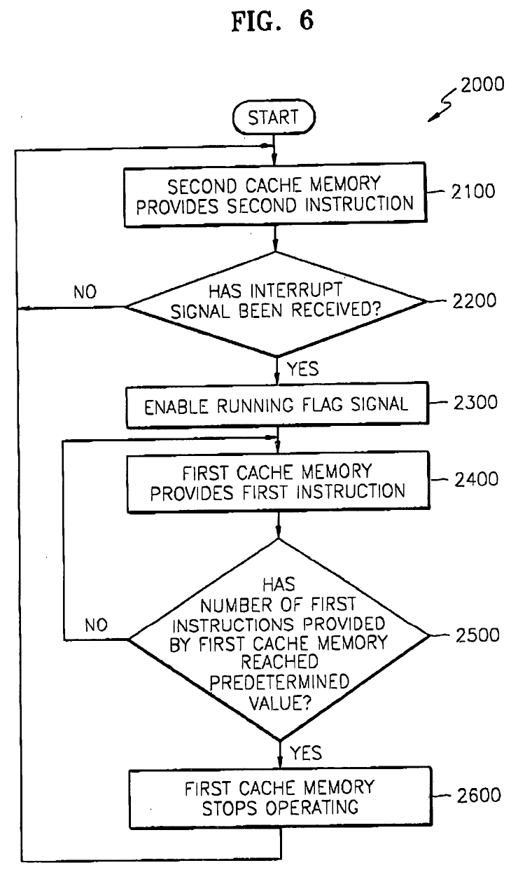

FIG. 6 is a flowchart describing a method of operating a cache memory device in accordance with an exemplary embodiment of the present invention. FIGS. 3-7 may be occasionally referred to in connection with the following. The general operation of the cache memory device is well known to those skilled in the art, and thus its explanation will not be presented here.

Referring to FIG. 6, initially the second cache memory 130 provides (function 2100) the second instruction INS_RE2 to the DSP core 10. Thereafter, it is determined (function 2200) whether or not the interrupt signal INT_ACK has been received. If the interrupt signal INT_ACK has been received (output of function 2200 is ‘YES’), the control signal generator 168 of the first cache memory 120 enables (function 2300) the running flag signal RUN_F, and the first cache memory 120 provides (function 2400) the first instruction INS_RE1 to the DSP core 10.

Next, it is determined (function 2500) whether or not the number of first instructions INS_RE1 provided by the first cache memory 120 reaches a predetermined or given number (i.e., threshold value). If the number of first instructions INS_RE1, equals the given number (output of function 2500 is ‘YES’), the first cache memory 120 stops operating (function 2600). Functions 2100 through 2600 may then be repeated until the DSP core 10 requests no further instructions (not shown for clarity).

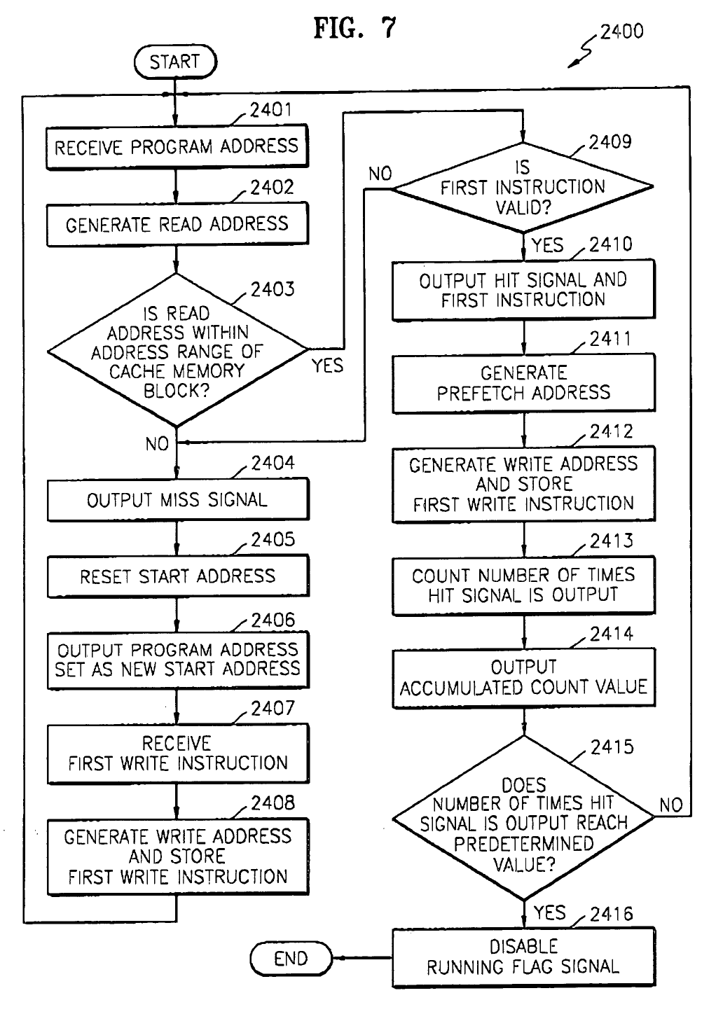

FIG. 7 is a flowchart describing function 2400 from FIG. 6 in further detail. Referring to FIG. 7, the first through third registers 161 through 163 of the first cache memory 120 receive (function 2401) a program address PRO_ADD. The first register 161 may output a series of program addresses PRO_ADD consecutively input thereinto as the request address REQ_ADD. The second register 162 stores the first PRO_ADD received from the series of program addresses and sets the first stored program address PRO_ADD as a start address BADD.

The first subtraction unit 164 then generates (function 2402) a read address RADD by subtracting the start address BADD from the request address REQ_ADD. For example, if the request address REQ_ADD has a value of 108 and the start address BADD has a value 100, the read address is 8.

The hit/miss determination unit 166 determines (function 2403) whether or not the read address RADD is within a given address range of the cache memory block 150. If the read address RADD is not within the given address range of the cache memory block 150 (output of function 2403 is ‘NO’), the hit/miss determination unit 166 outputs (function 2404) a miss signal MISS1. For example, and given that the cache memory block 150 includes addresses ranging from 0 to 99, a start address BADD is 100 and a request address REQ_ADD is 300. Thus, the read address RADD is 200. In this case, the read address RADD is not within the given address range (0-99) as the read address RADD substantially exceeds the maximum address value of 99 for the given address range. Thus, the miss signal MISS1 is output (function 2404) and the start address BADD needs to be reset (function 2405).

As another example, if the start address BADD is 100 and the request address REQ_ADD is 90, the read address RADD is −10, and is outside the address arrange (0-99) of the cache memory block 150. In this case, too, the miss signal MISS1 is output (function 2404) and the start address BADD needs to be reset (function 2405). In response to the miss signal MISS1, the control signal generator 168 outputs the control signal CTL to the second and third registers 162 and 163.

To reset the start address BADD in function 2405, the second register 162 responds to the control signal CTL by storing the program address PRO_ADD used to create the read address RADD, which is not within the address range of the cache memory block 150, and resets the start address BADD with the stored program address PRO_ADD. Accordingly, whenever the program address PRO_ADD jumps up or down too much, the start address BADD is reset. This process makes it possible to provide requested instructions to the DSP core 10 simply by using the storage registers 151 of the cache memory block 150.

Thereafter, the third register 163 outputs (function 2406) the program address PRO_ADD (reset as the start address BADD) to the program memory 40. The cache memory block 150 receives (function 2407) the first write instruction INS1 (which corresponds to the program address PRO_ADD) from the program memory 40. The second subtraction unit 165 then generates the write address WADD and stores the first write instruction INS1 in the cache memory block 150 (function 2408). The second subtraction unit 165 may create the write address WADD by subtracting the start address BADD from the program address PRO_ADD, for example. When resetting the start address BADD, the program address PRO_ADD and the start address BADD are the same; thus the write address WADD is 0.

Functions 2401 to 2408 may be repeatedly carried out until a read address RADD is within the given address range (the output of function 2403 is ‘YES’). If the read address RADD is within the give range, a validity check is performed. The hit/miss determination unit 166 checks (function 2409) a valid bit (VBIT) corresponding to the read address RADD determined as within the address range in function 2403. The valid bit checking of function 2409 determines whether or not the first instruction INS_RE1 corresponding to the read address RADD is valid. For example, if the valid bit VBIT has a value of “1”, the first instruction INS_RE1 is valid (output of function 2409 is ‘YES’). If the valid bit VBIT has a value of “0”, the first instruction INS_RE1 is invalid (output of function 2409 is ‘NO), and functions 2404 to 2409 are repeated until a first instruction INS_RE1 is determined to be valid.

When the first instruction INS_RE1 is valid, the hit/miss determination unit 166 outputs a hit signal HIT1 and the cache memory block 150 outputs the first instruction INS_RE1 (function 2410). The third register 163 stores the program address PRO_ADD, which is set as the start address BADD, and generates (function 2411) the prefetch address PRF_ADD. The prefetch address PRF_ADD may include a plurality of addresses that may consecutively increase (in value or number-wise) from the program address PRO_ADD stored in the third register 163.

When the first write instruction INS1 (corresponding to the prefetch address PRF_ADD) is received, the second subtraction unit 165 creates the write address WADD and stores the first write instruction INS1 in the cache memory block 150 (function 2412). The second subtraction unit 165 may create the write address WADD by subtracting the start address BADD from the prefetch address PRF_ADD, for example. The prefetch address PRF_ADD is transmitted to the program memory 40 by the second interface unit 140 of FIG. 3. The prefetch address PRF_ADD will be more fully described hereafter.

As an example, and supposing that the program address (which is set as the start address BADD) is 100, and the third register 163 generates the prefetch address PRF_ADD, which continuously increases from a value of 100 by one integer value (101, 102 . . . , etc.). The request address REQ_ADD may not be identical to the prefetch address PRF_ADD. For example, when the prefetch address PRF_ADD increases in the order of 100, 101, 102, 103, . . . , the request address REQ_ADD may irregularly increase on the order of 100, 103, 104, 106, 200, . . . , for example. This mismatch (REQ_ADD≠PRF_ADD) may occur because the third register 163 consecutively generates the prefetch address PRF_ADD at a higher speed than a speed at which the first register 161 receives the program address PRO_ADD for outputting the request address REQ_ADD.

Since the first cache memory 120 can efficiently transmit the first write instruction INS1 (received in response to the prefetch address PRF_ADD generated at the faster speed and sent to program memory 40), the first cache memory 120 can more quickly respond to a request issued by the DSP core 10 to forward the first instruction to the DSP core 10. Hence, the DSP core 10 can more quickly respond to an interrupt request.

Referring again to FIG. 7, whenever the hit signal HIT1 is output from the hit/miss determination unit 166, the counter 167 counts (function 2413) the number of times the hit signal HIT1 is output,accumulates the count value, and outputs (function 2414) the accumulated count value CNT. The control signal generator 168 compares the accumulated count value CNT with a given number or threshold and determines (function 2415) whether or not the number of times the hit signal HIT1 is output reaches a given or predetermined number (i.e., threshold value). If the number of times the hit signal HIT1 is output does not reach the given number (output of function 2415 is ‘NO’), functions 2401 to 2414 are repeatedly carried out until the hit signal HIT1 equals the given number.

When the number of times the hit signal HIT1 is output reaches the given number or threshold (output of function 2415 is ‘YES), the control signal generator 168 determines that the number of first instructions INS_RE1 (that are provided to the DSP core 10) has reached a given number or threshold and disables the running flag signal RUN_F, and the process of FIG. 7 is complete (function 2416). At this time, the control signal generator 168 output a reset signal RST to the counter 167.

The interrupt signal INT_ACK described with reference to FIGS. 6 and 7 is described in the context of being received only one time. However, additional interrupt signals may be received while processing the first or previously received interrupt signal INT_ACK. In a case where more than one interrupt signal INT_ACK is received, the first cache memory 120 may operate in the following exemplary manner.

The control signal generator 168 outputs a control signal CTL in response to the an additional or next interrupt signal INT_ACK received thereto as the first cache memory 120 is providing the first instruction INS_RE1 to the DSP core 10. In response to the control signal CTL, the second register 162 stores the program address PRO_ADD (which has been received first and foremost (see function 2401, for example)) together with the additionally received interrupt signal INT_ACK, and resets the start address BADD (see function 2405, for example) with the stored program address PRO_ADD. The counter 167 is reset in response to reset signal RST and restarts counting. Since the number of first instructions INS_RE1 (provided by the first cache memory 120 in response to an interrupt request) is set to a given number, the given number or threshold compared with the accumulated count value CNT by the control signal generator 168 is reset so as to be able to sufficiently respond to additional interrupt signals INT_ACKs in order to provide the first instruction INS_RE1 to the DSP core 10. Thereafter, the process returns to function 2406 so that the third register 163 outputs the program address PRO_ADD (reset as the new start address BADD) to the program memory 40, and then the above-described functions 2407 and 2408 may be carried out. Function 2400 may then be repeatedly carried out until the number of first instructions INS_RE1 reaches a given number.

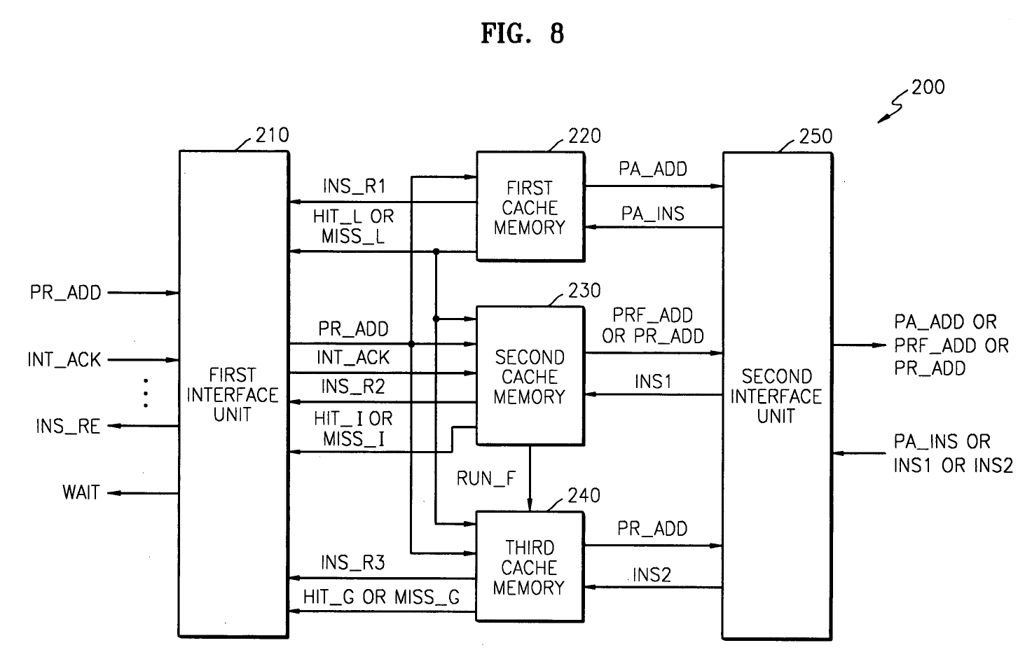

FIG. 8 is a block diagram of a cache memory device in accordance with another exemplary embodiment of the present invention. Referring to FIG. 8, a low power consumption cache memory device 200 may include a first interface unit 210, first cache memory 220, second cache memory 230, third cache memory 240, and a second interface unit 250. The first interface unit 210 that receives a program address PR_ADD and an interrupt signal INT_ACK (such as the interrupt signal INT_ACK from the DSP core 10 of FIG. 1). The first interface unit 210 may further receive signals used for writing or reading data required to control first through third cache memories 220 through 240.

The first interface unit 210 transmits the received interrupt signal INT_ACK and the received program address PR_ADD to the first through third cache memories 220, 230, and 240. In addition, the first interface unit 210 transmits a first instruction INS_R1, which is received from the first cache memory 220 together with a hit signal HIT_L, to the DSP core 10. The first interface unit 210 transmits a second instruction INS_R2, which is received from the second cache memory 230 together with a hit signal HIT_I, to the DSP core 10. The first interface unit 210 transmits a third instruction INS_R3, which is received from the third cache memory 240 together with a hit signal HIT_G, to the DSP core 10.

The first interface unit 210 outputs a wait signal WAIT to the DSP core 10 when miss signals MISS_L, MISS_I and MISS_G are received from the first, second, and third cache memories 220, 230, and 240, respectively, so that the DSP core 10 does not issue additional requests for instructions.

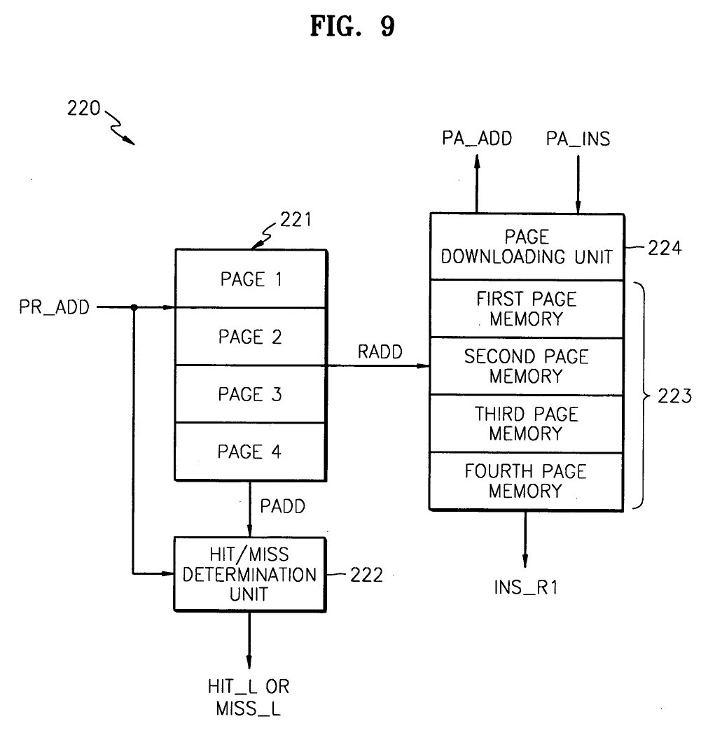

FIG. 9 is a detailed block diagram of first cache memory shown in FIG. 8. The first cache memory 220 may be embodied as a lockable cache memory, for example, although the first cache memory 220 may be embodied as another type of memory other than a lockable memory. Referring to FIG. 9, the first cache memory 220 may include address memory 221, a hit/miss determination unit 222, a page memory block 223, and a page downloading unit 224. The page memory block 223 includes a plurality of page memories that store instructions. The address memory 221 stores the addresses of the instructions stored in page memory block 223.

When the second cache memory 230 and third cache memory 240 are not accessing the program memory 40 of FIG. 1, a page downloading unit 224 may download a first write instruction PA_INS in advance. The page downloading unit 224 creates a page address PA_ADD, downloads the first write instruction PA_INS corresponding to the page address PA_ADD from the program memory 40 and stores the downloaded first write instruction PA_INS in the page memory block 223.

If the program address PR_ADD and a page address stored in the address memory 221 are identical, the hit/miss determination unit 222 outputs the hit signal HIT_L. If the program address PR_ADD does not exist in the address memory 221, the hit/miss determination unit 222 outputs the miss signal MISS_L.

As shown in FIG. 8, when an interrupt request is issued (the interrupt signal INT_ACK received by first interface unit 210 from DSP 10), the second cache memory 230 stores given instructions for the DSP core 10 to execute an interrupt service routine. The second cache memory 230 may be configured as an interrupt cache memory, for example, and operates when there is an interrupt request. The second cache memory 230 may start operating when it receives the miss signal MISS_L from the first cache memory 220 and the interrupt signal INT_ACK from the first interface unit 210. The second cache memory 230 enables the running flag signal RUN_F in response to the interrupt signal INT_ACK.

If there exists the second instruction INS_R2 corresponding to the program address PR_ADD, the second cache memory 230 outputs the second instruction INS_R2 together with the hit signal HIT_I. If the second instruction INS_R2 does not exist or is not valid, the second cache memory 230 outputs the miss signal MISS_I.

The second cache memory 230 may generate a prefetch address PRF_ADD using the program address PR_ADD and output the prefetch address PRF_ADD to a second interface device 250. The second cache memory 230 receives the second write instruction INS1 (corresponding to the prefetch address PRF_ADD) from the second interface device 250. The second cache memory 230 stops operating and disables the running flag signal RUN_F once it has sent a given number of second instructions INS_R2 to the DSP core 10. The given number may be set to be equal to the number of instructions that are necessary for the DSP core 10 to check an interrupt request state and read relevant input variables, for example.

The third cache memory 240 starts operating when the running flag signal RUN_F is disabled, and outputs the third instruction INS_R3 together with the hit signal HIT_G if the third instruction INS_R3 (which corresponds to the program address PR_ADD) exists. If the third instruction INS_R3 does not exist, the third cache memory 240 outputs the miss signal MISS_G.

The second interface device 250 receives one of a page address PA_ADD from first cache memory 220, prefetch address PRF_ADD from second cache memory 220, and program address PR_ADD from the second cache memory 220 or third cache memory 230, and transmits the received address to the program memory 40, as shown in FIG. 8.

The second interface device 250 receives the first write instruction PA_INS from the program memory 40 and transmits the received first write instruction PA_INS to the first cache memory 220. In addition, the second interface device 250 receives the second write instruction INS1 from the program memory 40 and transmits the received second write instruction INS1 to the second cache memory 230. The second interface device 250 also receives the third write instruction INS2 from the program memory 40 and transmits the received third write instruction INS2 to the third cache memory 240. The third cache memory 240 may thus provide instructions to enable the DSP core 10 to execute a regular program, or provides instructions necessary for the DSP core 10 to execute an interrupt service routine after reading relevant input variables.

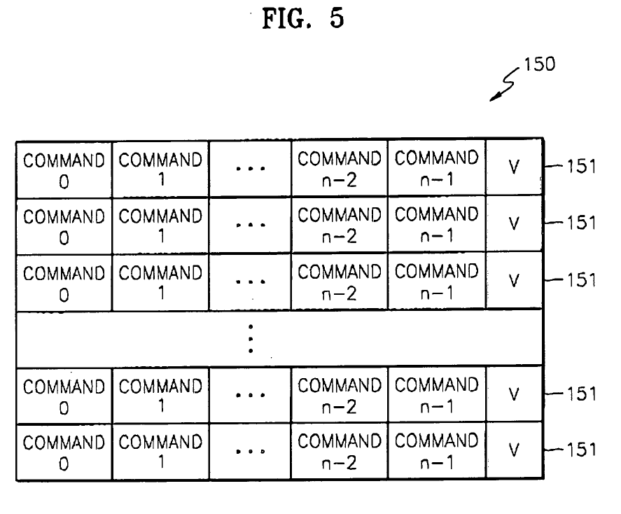

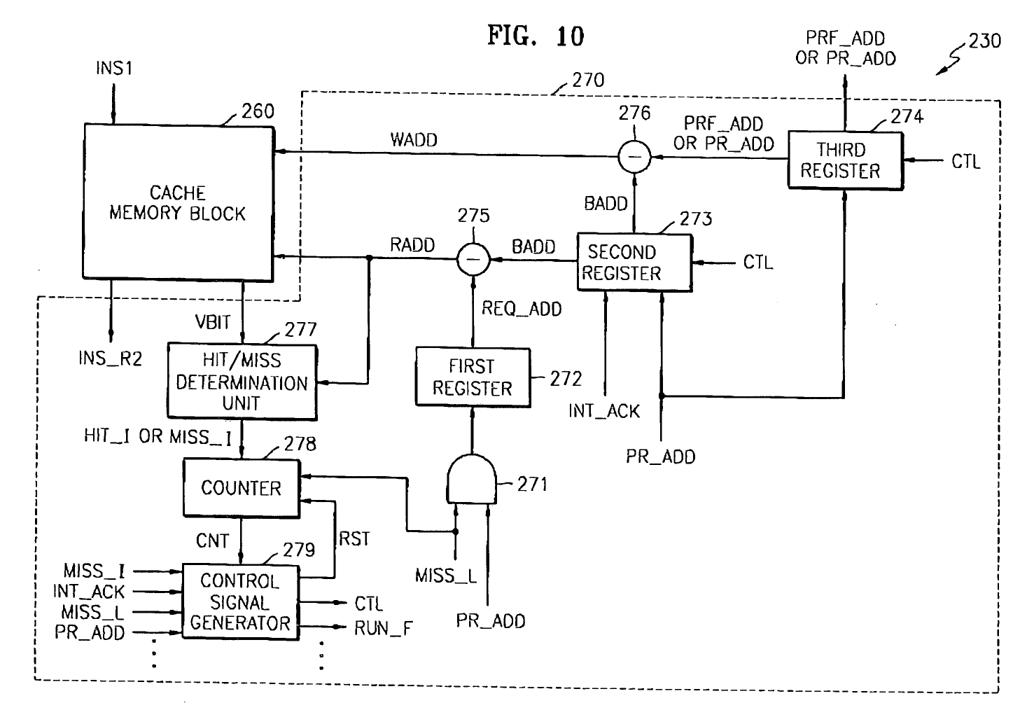

FIG. 10 is a detailed block diagram of the second cache memory 230 of FIG. 8. Referring to FIG. 10, the second cache memory 230 may include a cache memory block 260, the structure and operation of which is the same as the cache memory block 150 of FIG. 5 and is thus not repeated for reasons of brevity.

The second cache memory may include a cache controller 270. The cache controller 270 may include an input circuit 271, first through third registers 272 through 274, first and second subtraction devices 275 and 276, a hit/miss determination unit 277, a counter 278, and a control signal generator 279. As the structure and operation of the cache controller 270 is substantially similar to that described for the cache controller 160 of FIG. 4, a detailed description will not be repeated here for reasons of brevity.

A difference between the cache controller 270 and the cache controller 160 is that the cache controller 270 includes the input circuit 271. Another difference is that the control signal generator 279 of the cache controller 270 in FIG. 10 further receives the miss signal MISS_L from the first cache memory 220. The input circuit 271 outputs the program address PR_ADD to the first register 272 when the miss signal MISS_L is received. The counter 278 operates in response to the miss signal MISS_L and counts the number of times the hit signal HIT-1 is output from the hit/miss determination unit 277 and accumulates the count value and output the accumulated count value CNT. The second cache memory 230 starts operating when it receives the miss signal MISS_L output from the first cache memory 220 and the interrupt signal INT_ACK from the first interface unit 210.

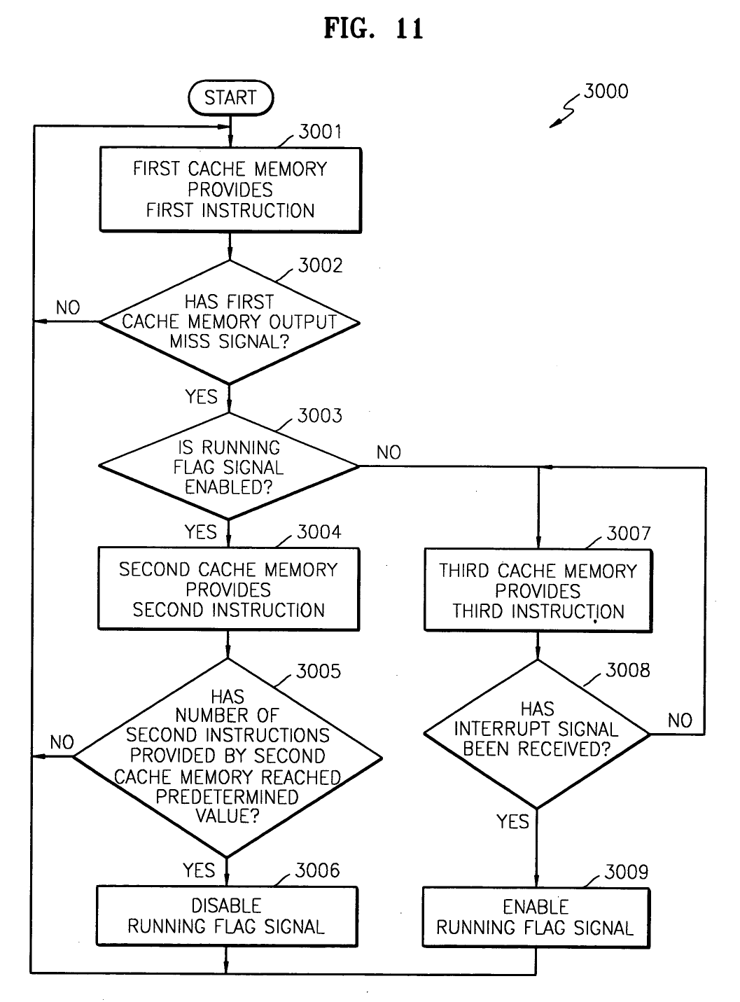

FIG. 11 is a flowchart describing a method of operating a cache memory device in accordance with another exemplary embodiment of the present invention. Flowchart 300 may be used to describe operation of an exemplary low power consumption cache memory device for a DSP when there is an interrupt request, for example.

Referring to FIG. 11, the first cache memory 220 provides the first instruction INS_R1 to the DSP core 10 (function 3001). Thereafter, it is determined (function 3002) whether or not the miss signal MISS_L is output from the first cache memory 220. If the miss signal MISS_L is output (output of function 3002 is ‘YES’), it is next determined (function 3003) whether or not the running flag signal RUN_F is enabled. If the running flag signal RUN_F is enabled (output of function 3003 is ‘YES’), the running flag signal RUN_F indicates a state where an instruction can be provided in response to an interrupt request. Thus, the second cache memory 230 provides (function 3004) the second instruction INS_R to the DSP core 10, as described in detail in FIG. 7 with regard to the analogous function 2400 performed by first cache memory 120. Thus a detailed description of function 3004 will not be repeated here for sake of brevity.

Next it is determined (function 3005) whether or not the number of second instructions INS_R2, provided by the second cache memory 230, reaches a given value. If the number of second instructions INS_R2, equals the given value (output of function 3005 is ‘YES’), the second cache memory 230 stops operating and disables the running flag signal RUN_F (function 3006). Functions 3001 to 3006 may then be repeatedly carried out until the DSP core 10 request no further instructions. If the number of second instructions INS_R2 does not equal the given value(output of function 3005 is ‘NO’), functions 3001 to 3005 may be repeatedly carried out until the number of second instructions INS_R2 equals the given value.

If the running flag signal RUN_F is disabled (output of function 3003 is ‘NO’), the third cache memory 240 provides (function 3007) the third instruction INS_R3 to the DSP core 10. Thereafter, it is determined whether or not the interrupt signal INT_ACK is received (function 3008). The second cache memory 230 enables the running flag signal RUN_F (function 3009) when it receives the interrupt signal INT_ACK (output of function 3008 is ‘YES’); otherwise function 3007 is repeated until it has been determined that the interrupt signal INT_ACK has been received. Functions 3001 to 3009 may be repeatedly carried out until the DSP core 10 requests no further instruction.

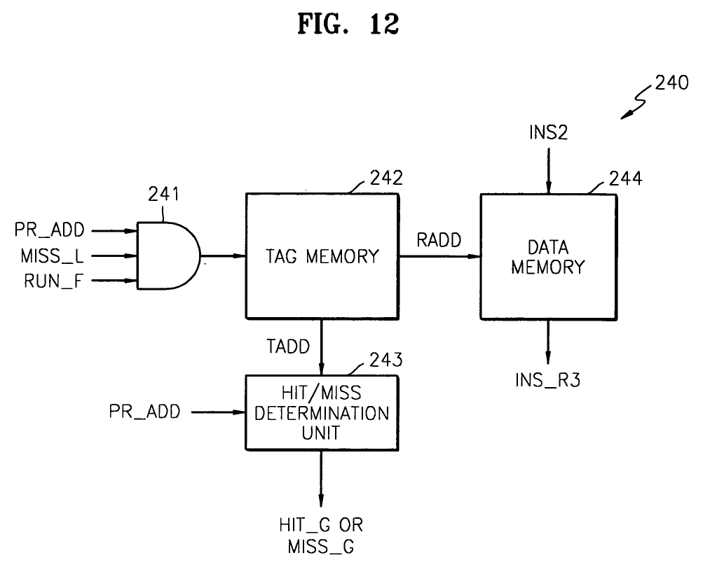

FIG. 12 is a detailed block diagram of the third cache memory 240 of FIG. 8. Referring to FIG. 12, the third cache memory 240 may include an input circuit 241, tag memory 242, a hit/miss determination unit 243, and data memory 244. The input circuit 241 outputs the program address PR_ADD to the tag memory 242 when it receives the miss signal MISS_L and the disabled running flag signal RUN_F. The tag memory 242 stores a line address TADD, which indicates information on instructions stored in the data memory 244. If the program address PR_ADD and the line address are identical, the hit/miss determination unit 243 outputs the hit signal HIT_G. Otherwise, the hit/miss determination unit 243 outputs the miss signal MISS_G. When the hit signal HIT_G is output, the data memory 244 outputs the third instruction INS_R3 corresponding to the read address RADD. The third cache memory 240 may be manufactured to have a direct-mapped cache structure, for example, in an effort to guarantee low power consumption and facilitate accessibility. However, the third cache memory 240 is not limited to a direct-mapped cache structure, as other cache structures may be envisioned for third cache memory 240.

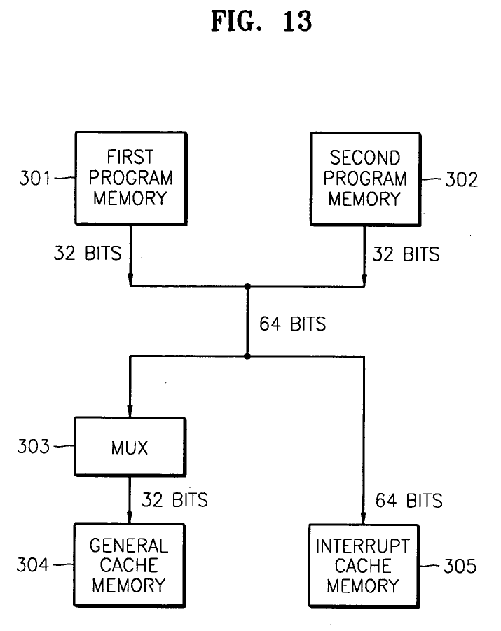

FIG. 13 is a block diagram illustrating a comparison of the input bandwidth of cache memory for an interrupt service routine with the input bandwidth of cache memory for general use. In FIG. 13, interrupt cache memory 305 may correspond to the first cache memory 120 of FIG. 3 or the second cache memory 230 of FIG. 8; and a general cache memory 304 may correspond to the second cache memory 130 of FIG. 3 or the third cache memory 240 of FIG. 8.

As shown in FIG. 13, first and second program memories 301 and 302 configured so as to have a substantially large storage capacity are connected to the general cache memory 304 and the interrupt cache memory 305. The general cache memory 304 may receive data from the first program memory 301 or the second program memory 302 due to a multiplexer 303. The interrupt cache memory 305 receives data from the first and second memories 301 and 302.

The general cache memory 304 and the interrupt cache memory 305 have different input bandwidths. For example, the input bandwidth of the interrupt cache memory 305 may be two times wider than the input bandwidth of the general cache memory 304, although the differences in bandwidth between the two memories may be a factor other than two, for example.

For purposes of explanation only, each of the first and second program memories 301 and 302 may output 32-bit data. Since the general cache memory 304 receives data either from the first program memory 301 or from the second program memory 302 (due to the existence of the multiplexer 303) the general cache memory 304 has a 32-bit input bandwidth. On the other hand, the interrupt cache memory 305 receives data from both the first and second program memories 301 and 302 and thus has a 64-bit input bandwidth.

Therefore, when an interrupt request is issued, the interrupt cache memory 305, due to its higher bandwidth, may provide instructions (requested by the DSP core 10) quicker to the DSP core 10 than the general cache memory 304. During operations other than the interrupt service routine, the general cache memory 304 may be more effective, however, in terms of low power consumption because it accesses either the first or second program memory 301 or 302 in stead of both memories 301 and 302. Even though two program memories are illustrated in FIG. 13, the exemplary embodiments also envision more than two program memories connected to the general cache memory 304 and the interrupt cache memory 305.

Accordingly, the cache memory device and a method of controlling the cache memory device in accordance with the exemplary embodiments of the present invention may be capable of responding quicker to interrupt requests, with reduced power consumption, than conventional devices.

The exemplary embodiments of the present invention being thus described, it will be obvious that the same may be varied in many ways. Such variations are not to be regarded as departure from the spirit and scope of the exemplary embodiments of the present invention, and all such modifications as would be obvious to one skilled in the art are intended to be included within the scope of the following claims.

What is claimed is:

1. A cache memory device for a digital signal processor (DSP), comprising:
a first cache memory for enabling a running flag signal in response to a given interrupt signal from a DSP core of the DSP to provide a given number of first instructions to the DSP core, and for disabling the running flag signal; and
a second cache memory for providing at least one second instruction to the DSP core when the running flag signal is disabled.

2. The cache memory device of claim 1, further comprising:
a first interface unit which interfaces the DSP core, first cache memory and second cache memory; and
a second interface unit which interfaces the first cache memory, second cache memory and a program memory that stores instructions for the DSP core.

3. The cache memory device of claim 1, wherein the given number of first instructions enable the DSP core to check a state of the interrupt request and to read relevant input variables.

4. The cache memory device of claim 2, wherein the first cache memory includes:
a cache memory block which stores a given one of the given number of first instructions received from the program memory in response to a corresponding write address and outputs each one of the given number of first instructions in response to a corresponding read address; and
a cache controller which generates the write address, read address, and a prefetch address using a program address received from the DSP core via the first interface unit, wherein the cache controller transmits the prefetch address to the program memory via the second interface unit in order to receive a given first instruction.

5. The cache memory device of claim 4, wherein the cache controller further includes:
a first register which receives the program address from the first interface unit and outputs the program address as a request address;
a second register which, in response to the interrupt signal sets a first received program address as a start address;
a third register which generates the prefetch address based on the start address;
a first subtraction unit which subtracts the start address from the request address to output the read address to the cache memory block;
a second subtraction unit which subtracts the start address from the prefetch address to output the write address to the cache memory block;
a hit/miss determination unit which outputs a hit signal if the read address is determined as valid, and which otherwise outputs a miss signal;
a counter which counts a number of times the hit signal is output, accumulates the count value and outputs the accumulated count value; and
a control signal generator which determines whether or not the number of times the hit signal is output reaches a threshold value based on the accumulated count value and enables the running flag signal when the number of times the hit signal is output reaches the threshold value.

6. The cache memory device of claim 5, wherein
the third register generates the prefetch address when the hit signal is output from the hit/miss determination unit, and
the prefetch address includes a plurality of addresses that continuously increase in value from the start address.

7. The cache memory device of claim 5, wherein the counter is reset when another interrupt signal is received.

8. The cache memory device of claim 5, wherein
the hit/miss determination unit outputs the miss signal if the read address output from the first subtraction unit is outside a given address range of the cache memory block or if the first instruction corresponding to the read address is invalid,
the control signal generator outputs a given control signal in response to the miss signal, and
the second register resets the start address in response to the control signal.

9. The cache memory device of claim 8, wherein
the second register stores the program address used to generate the read address that is outside the given address range and sets the stored program address as a new start address in response to the control signal, and
the third register transmits the new start address to the program memory in response to the control signal.

10. A method of controlling a cache memory device in a digital signal processor (DSP), comprising:
(a) first providing an instruction to a DSP core of the DSP from a cache memory, in response to a request from the DSP core;
(b) enabling a running flag signal in another cache memory in response to an interrupt signal received thereto from the DSP core;
(c) second providing, in response to a request from the DSP core, a given number of instructions from the another cache memory to the DSP core that are different from the first provided instruction; and
(d) disabling the running flag signal and ceasing said second providing step when the given number of instructions reaches a threshold value.

11. The method of claim 10, further comprising:
(e) repeating steps (a) through (d) iteratively until there are no further instruction requests from the DSP core.

12. The method of claim 10, wherein step (c) further includes:
(c1) generating a read address in response to a received program address;
(c2) outputting a miss signal and resetting a start address if the read address is not within a given address range, or if one of the given number of instructions corresponding to the read address is invalid;
(c3) transmitting the reset start address in order to receive a write instruction;
(c4) generating a write address based on the reset start address and storing the write instruction;
(c5) outputting a hit signal and the write instruction if the read address is within the given address range, or if the given instruction corresponding to the read address is valid;
(c6) counting a number of times the hit signal is output;
(c7) outputting an accumulated count value; and
(c8) iteratively repeating steps (c1) through (c6) to provide the given number of instructions, until a count value of the counting in step (c6) reaches a given value.

13. The method of claim 10, further comprising:
(f) determining whether or not the given number of instructions in step (c) reaches the given value based on the accumulated count value.

14. The method of claim 12, wherein step (c1) further includes:
(c11) setting a first received one of a plurality of received program addresses as a start address; and
(c12) generating the read address by subtracting the start address from a request address that represents a plurality of consecutively received program addresses.

15. The method of claim 12, wherein
the start address reset in step (c2) is the program address corresponding to the read address for which the miss signal is output, and
step (c4) further includes generating the write address by subtracting the reset start address from the received program address.

16. The method of claim 12, wherein step (c5) further includes:
(c51) generating a prefetch address using the start address;
(c52) generating a write address by subtracting the start address from the prefetch address; and
(c53) storing the write instruction corresponding to the prefetch address.

17. A cache memory device for a digital signal processor (DSP), comprising:
a first cache memory providing a first instruction in response to a program address received from a DSP core of the DSP, if there is no first instruction corresponding to the program address, and outputting a first miss signal;
a second cache memory providing at least one second instruction to the DSP core in response to a given interrupt signal and the first miss signal and, the second cache memory further disabling a running flag signal based after a given number of second instructions have been provided to the DSP core; and
a third cache memory which provides a third instruction to the DSP core in response to the first miss signal, when the running flag signal is disabled.

18. The cache memory device of claim 17, further comprising:
a first interface unit which interfaces the DSP core, first cache memory second cache memory and third cache memory; and
a second interface unit which interfaces the first cache memory, second cache memory, third cache memory and a program memory that stores instructions for the DSP core.

19. The cache memory device of claim 18, wherein the second cache memory includes:
a cache memory block which stores the second instructions, each second instruction received from the program memory in response to a corresponding write address, each second instruction output from the cache memory block in response to a corresponding read address; and
a cache controller which generates the write address, the read address, and a prefetch address using the program address received from the DSP core via the first interface unit, the cache controller transmitting the prefetch address to the program memory via the second interface unit.

20. The cache memory device of claim 19, wherein the cache controller includes:
an input circuit which outputs the program address received in response to the first miss signal;
a first register which outputs the program address as a request address;
a second register which sets a first received program address as a start address in response to the interrupt signal;
a third register which generates the prefetch address using the start address;
a first subtraction unit which subtracts the start address from the request address to output the read address;
a second subtraction unit which subtracts the start address from the prefetch address to output the write address;
a hit/miss determination unit which outputs one of a hit signal and a second miss signal depending on a determination result;
a counter which counts the number of times the hit signal is output, accumulates the count value and outputs the accumulated count value; and
a control signal generator which enables the running flag signal in response to the interrupt signal and disables the running flag signal, if the accumulated count value reaches the threshold value.

21. The cache memory device of claim 20, wherein
the determination result outputs the second miss signal when the read address is not within a given address range of the cache memory block or the second instruction corresponding to the read address is invalid,
the control signal generator outputs a given control signal in response to the second miss signal,
the second register resets the start address in response to the control signal, and
the third register generates the prefetch address using the start address, which has been reset in response to the control signal.

22. A method of controlling a cache memory device in a digital signal processor (DSP), comprising:
(a) first providing a first instruction from a first cache memory to a DSP core in response to a program address received from the DSP core;
(b) second providing at least one second instruction from a second cache memory to the DSP core in response to the program address based on at least one of an output of a first miss signal from the first cache memory and an enabling of a running flag signal by the second cache memory;
(c) disabling the running flag signal and ceasing step (b) when a number of second instructions provided to the DSP core reaches a given value;
(d) third providing a third instruction from a third cache memory to the DSP core in response to the program address based on at least one the first miss signal output from the first cache memory and a disabling of the running flag signal by the second cache memory;
(e) enabling the running flag signal at the second cache memory when an interrupt signal is received thereto from the DSP core.

23. The method of claim 22, further comprising:
(f) iteratively repeating steps (a) through (e) until there are no further instruction requests received from the DSP core.

24. The method of claim 22, wherein step (b) includes:
(b1) generating a read address from a program address;
(b2) outputting a second miss signal and resetting a start address if the read address is not within a given address range or if the second instruction corresponding to the read address is invalid;
(b3) transmitting the reset start address to receive a second write instruction to be stored;
(b4) generating a write address based on the reset start address and storing a second write instruction;
(b5) outputting a hit signal and the second instruction if the read address is within a given address range or if the second instruction corresponding to the read address is valid;
(b6) counting the number of times the hit signal is output; and
(b7) iteratively repeating steps (b1) through (b6) until a count value of the counting in step (b6) reaches a given value.

25. A cache memory device for a digital signal processor (DSP) that is controlled in accordance with the method of claim 10.

26. A cache memory device for a digital signal processor (DSP) that is controlled in accordance with the method of claim 22.
